(19) United States
(12) Patent Application Publication
(10) Pub. No.: US 2016/0229221 A1
(43) Pub. Date: Aug. 11, 2016

(54) MULTIPROJECTION DEVICE

(71) Applicant: Nottingham Spirk Design Associates, Cleveland, OH (US)

(72) Inventors: Rachel NOTTINGHAM COLOSIMO, Cleveland Heights, OH (US); Carolyn M. MCNEELEY, University Heights, OH (US); Nicholas E. STANCA, Westlake, OH (US); Rebecca L. BLICE, Akron, OH (US); James E. SZPAK, Cleveland Heights, OH (US); Richard A. KLINK, Berea, OH (US)

(21) Appl. No.: 14/615,785

(22) Filed: Feb. 6, 2015

(51) Int. Cl. B43K 29/10; G02B 3/08; B43K 29/007; G03B 21/14; B43K 8/02; B43K 23/08

(52) U.S. Cl. CPC B43K 29/10; B43K 8/02; B43K 23/08; B43K 29/007; G03B 21/145; G02B 3/08

(57) ABSTRACT

A multiprojection device comprising a housing having a first end and an interior, a battery-powered light source held in the interior of the housing such that light from the battery-powered light source travels axially along the interior of the housing towards the first end, a transparency bearing an image and axially aligned with the battery-powered light source in the housing such that light from the battery-powered light source travels axially along the interior of the housing towards the first end through the transparency, and a lens disposed at the first end such that light from the battery-powered light source travels axially along the interior of the housing towards the first end through the transparency and out of the lens, wherein multiple simultaneous instances of the image are projected from the multiprojection device.

### FIELD OF THE INVENTION

The present disclosure relates generally to the field of projection devices. In particular, the present disclosure relates to a device that projects multiple simultaneous instances of an image. The device may be combined with a writing device.

### BACKGROUND

Marketers often display their names, characters or trademarks on writing devices such as pencils, pens and markers as advertising. Writing devices marketed to adults and children also often bear cartoons or other characters. Conventionally marketers simply printed or impressed these images onto the writing device. Later, marketers developed writing devices that displayed these images by projecting the images onto a nearby surface. These writing devices with image projection capabilities, however, were limited at least in that they projected a single image or a single instance of an image. A single image projected onto a nearby surface has limited appeal.

### SUMMARY OF THE INVENTION

The invention relates to an image projecting device that projects multiple simultaneous instances of an image. In one embodiment, the image projecting device includes a projecting multifaceted lens. Because the lens is multi-faceted, light carrying the image travels through each of the multiple facets and projects multiple instances (one instance for every facet) of the image onto nearby surfaces. In one embodiment, the image projecting device is combined with a writing device (e.g., a marker).

These and further features of the present invention will be described with reference to the attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the terms of the appended claims.

In the present disclosure, embodiments are described primarily in the context of a writing device—a marker. It should be appreciated, however, that the exemplary context of a writing device is not the only operational environment in which aspects of the disclosed invention may be used. Therefore, the projection techniques described in this disclosure may be applied to devices other than writing devices.

### BRIEF DESCRIPTION OF THE DRAWINGS

The accompanying drawings, which are incorporated in and constitute a part of the specification, illustrate various example systems, methods, and so on, that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates a perspective view of an exemplary projection device.

FIG. 2 illustrates a perspective view of the exemplary projection device of FIG. 1 writing or marking on a surface.

FIG. 3 illustrates exemplary details of the internals of the exemplary projection device of FIG. 1.

FIG. 4 illustrates a perspective view of an exemplary projection device of FIG. 1 projecting multiple instances of an image.

FIG. 5 illustrates a perspective view of an exemplary projection device of FIG. 1 projecting and performing rotation of its projection of multiple instances of an image.

### DETAILED DESCRIPTION

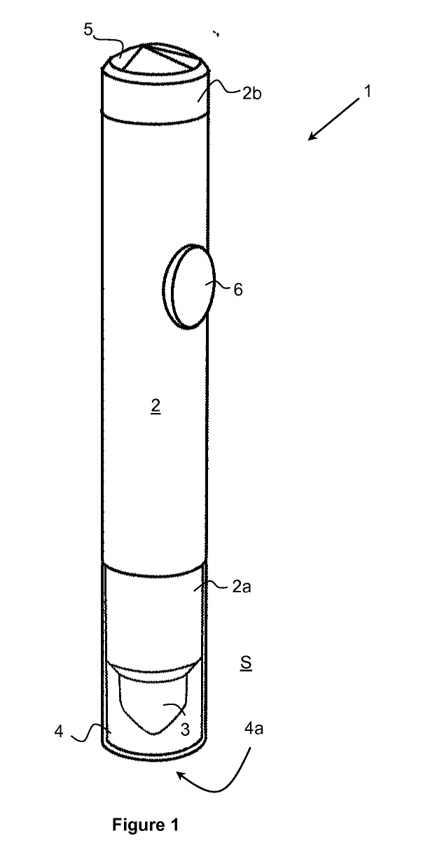

FIG. 1 illustrates a perspective view of an exemplary projection device 1. The projection device 1 includes a housing 2 that has a writing or marker end 2a and a projection end 2b.

The projection device 1 includes a writing or marker nib 3 that is operably attached to the marker end 2a and may be covered by a cap 4. The cap 4 is releasably attachable to the marker end 2a to, when attached, cover the marker nib 3. The end 4a of the cap 4 is substantially flat such that, when the cap 4 is attached to the housing 2 and the end 4a rests on a horizontally flat surface S, the projection device 1 stands stably upright on the surface S. This feature becomes particularly relevant in the context of projecting the image as discussed in more detail below. The flat marker cap end 4a allows for the display or storing of the marker 1 in an upright position. In one embodiment, the projection device 1 used as a projector may be set to project the image while resting on the surface S via the cap 4 in an unassisted manner.

The projection device 1 also includes a projection lens 5 that is operably attached to the projection end 2b and a power switch 6 that will be described in more detail below.

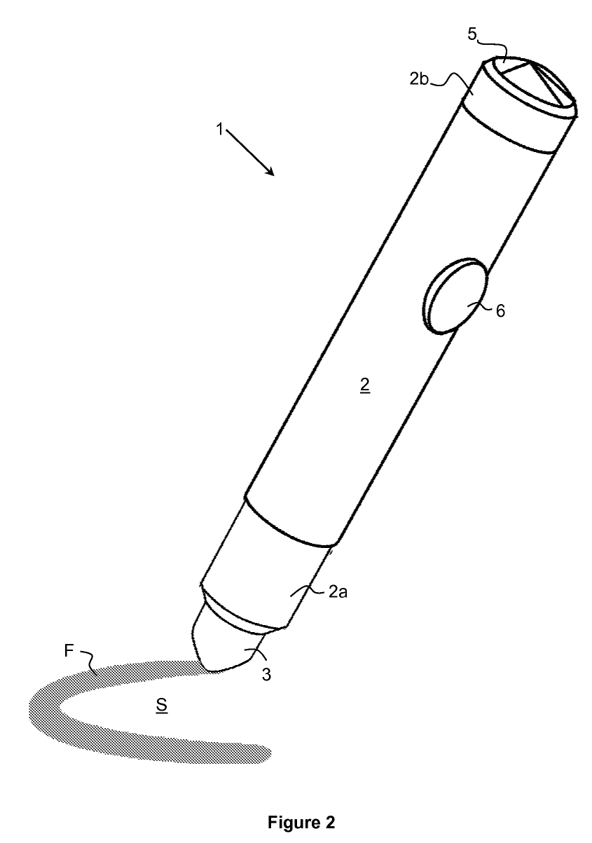

FIG. 2 illustrates a perspective view of the exemplary projection device of FIG. 1 writing or marking on a surface S (e.g., paper, etc.) In FIG. 2, the cap 4 has been removed and the marker nib 3 is therefore exposed. The marker nib 3 receives a colored fluid F such as ink, paint, etc. from within the interior of the housing 2 and transfers the fluid F to the surface S external to the projection device 1. When finished writing, a user may once again cover the marker nib 3 with the cap 4.

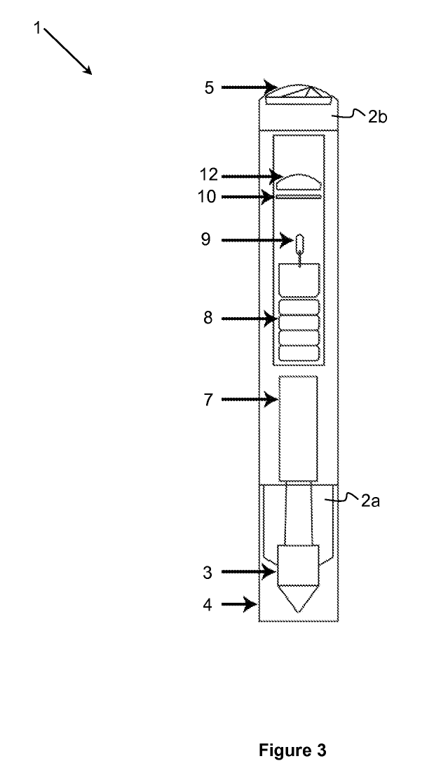

FIG. 3 illustrates exemplary details of the internals of the exemplary projection device 1. Inside the housing 2, the projection device 1 includes and ink reservoir or filament 7 from which the fluid ink F is transferred to the marker nib 3.

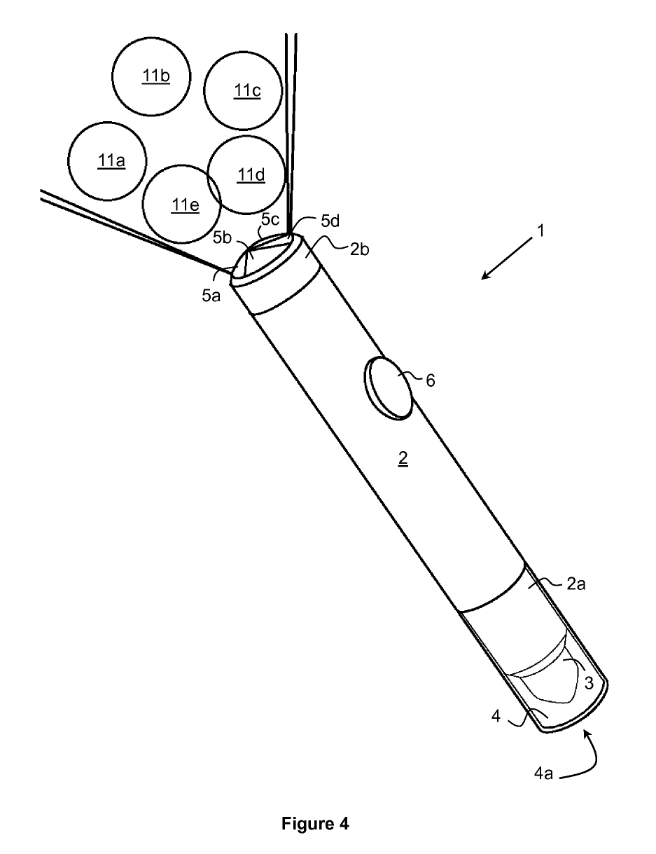

The projection device 1 also includes a battery or batteries 8, a light source 9 and the power switch 6 (not shown in FIG. 3), which are electrically connected. Operation of the power switch 6 controls operation of the light source 9. The light source 9 is held in the interior of the housing 2 such that light from the light source 9 travels axially along the interior of the housing 2 towards the projection end 2b. The projection device 1 also includes an image carrier or transparency 10 that carries (i.e., has impressed upon) an image (shown in FIG. 4 as instances 11a-e). The image carrier 10 is held axially aligned with the light source 9 in the housing 2 such that light from the light source 9 travels axially along the interior of the housing 2 towards the projection end 2b through the image carrier 10. In the illustrated embodiment, the projection device 1 also includes the internal lens 12 (as shown in FIG. 3) through which the light from the light source 9 may travel before reaching the projection lens 5. In other embodiments, the projection device 1 does not include the lens 12.

FIG. 4 illustrates a perspective view of the exemplary projection device 1 projecting multiple simultaneous instances of the image 11. As described above, the projection device 1 includes the projection lens 5. The projection lens 5 is multifaceted, meaning that it has multiple non-parallel surfaces 5a, 5b, 5c, 5d, etc. The projection lens 5 is operably attached to the projection end 2b such that light from the light source 9 travels axially along the interior of the housing 2 towards the projection end 2b through the image carrier 10 and out of the multiple surfaces 5a, 5b, 5c, 5d, etc. of the lens 5.

The multiple surfaces 5a, 5b, 5c, 5d, etc. of the lens 5 divide the light from the light source into multiple portions, each corresponding to a respective one of the non-parallel surfaces 5a, 5b, 5c, 5d, etc. of the lens 5. This way the projection device 1 projects multiple simultaneous instances of the image 11 onto nearby surfaces. In the illustrated embodiment of FIG. 4, the lens 5 has five non-parallel surfaces 5a, 5b, 5c, 5d, etc. and therefore the projection device 1 projects five instances 11a, 11b, 11c, 11d, and 11e of the image 11. In other embodiments, the lens 5 has more (e.g., 6-20) or fewer (e.g., 2-4) than five non-parallel surfaces and therefore the projection device 1 projects a corresponding number of instances of the image 11.

In one embodiment, the non-parallel surfaces 5a, 5b, 5c, 5d, etc. of the lens 5 are internal to the lens 5. In this embodiment, the exterior or the exposed portion of the lens 5 may be a single or smooth surface. In another embodiment, the non-parallel surfaces 5a, 5b, 5c, 5d, etc. of the lens 5 may be external to the lens 5 or the non-parallel surfaces 5a, 5b, 5c, 5d, etc. may be internal and external to the lens 5. This means that, in this embodiment, the exterior or the exposed portion of the lens 5 may be formed by the non-parallel surfaces 5a, 5b, 5c, 5d, etc. The non-parallel surfaces 5a, 5b, 5c, 5d, etc. may create an effect (e.g., fisheye, etc.) on the instances of the image 11 or may simply pass or redirect the light (i.e., the instance of the image 11) in particular directions towards nearby surfaces.

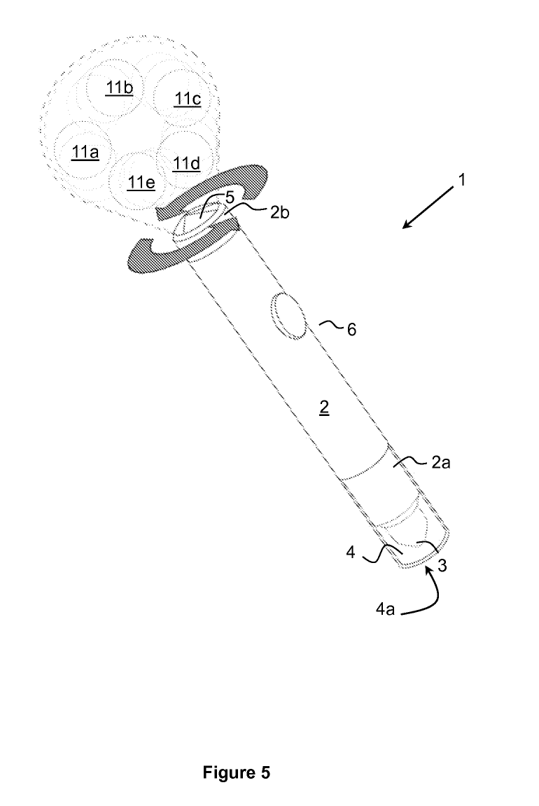

FIG. 5 illustrates a perspective view of the exemplary projection device 1. In the illustrated embodiment, the projection lens 5 is rotatably attached to the housing 2 so that the lens 5 may be rotated about the longitudinal axis of the projection device 1. When the power switch 6 is on and the projection device 1 is projecting the multiple instances 11a, 11b, 11c, 11d, and 11e of the image 11, the projection lens 5 may be rotated which causes its projection of the multiple instances 11a, 11b, 11c, 11d, and 11e of the image 11 to also rotate. In the illustrated embodiment, rotation of the projection lens 5 is accomplished by manually rotating the projection lens 5 about the longitudinal axis of the projection device 1. In another embodiment, rotation of the projection lens 5 may be accomplished by motorized (e.g., electrical motor connected to the power switch 6 and the battery 8) rotating the projection lens 5 about the longitudinal axis of the projection device 1.

In one embodiment (not shown), the projection lens 5 of the projection device 1 has a single surface instead of multiple surfaces. In this embodiment, the image carrier 10 has impressed thereon the multiple instances of the image 11. The image carrier 10 is held axially aligned with the light source 9 in the housing 2 such that light from the light source 9 travels axially along the interior of the housing 2 towards the projection end 2b through the image carrier 10 and projects out of the lens 5. In this alternative way, the projection device 1 projects multiple simultaneous instances of the image 11 onto nearby surfaces.

While example systems, methods, and so on, have been illustrated by describing examples, and while the examples have been described in considerable detail, it is not the intention to restrict or in any way limit the scope of the appended claims to such detail. It is, of course, not possible to describe every conceivable combination of components or methodologies for purposes of describing the systems, methods, and so on, described herein. Additional advantages and modifications will readily appear to those skilled in the art. Therefore, the invention is not limited to the specific details, and illustrative examples shown or described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components. An “operable connection,” or a connection by which entities are “operably connected,” is one by which the operably connected entities or the operable connection perform its intended purpose. For example, two entities may be operably connected to each other directly or through one or more intermediate entities.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (3D. Ed. 1995).

What is claimed is:

1. A projection device comprising:
a housing having a projection end, a marker end and an interior;
a marker nib operably attached to the marker end and configured to receive ink from within the interior of the housing and transfer the ink to a surface external to the projection device;
a battery-powered light source held in the interior of the housing such that light from the battery-powered light source travels axially along the interior of the housing towards the projection end;
an image carrier carrying an image thereon and held axially aligned with the battery-powered light source in the housing such that light from the battery-powered light source travels axially along the interior of the housing towards the projection end through the image carrier; and
a multifaceted lens having non-parallel surfaces and operably attached to the projection end such that light from the battery-powered light source travels axially along the interior of the housing towards the projection end through the image carrier and out of the multifaceted lens, wherein the multifaceted lens divides the light into multiple portions corresponding to the non-parallel surfaces such that multiple instances of the image are projected from the projection device.

2. The projection device of claim 1, comprising:
a cap releasably attachable to the marker end of the housing to, when the cap is attached to the housing, cover the marker nib, and, when the cap is released from the housing, the marker nib is exposed.

3. The projection device of claim 1, comprising:
a cap releasably attachable to the marker end of the housing and having an end opposite the marker end that is substantially flat such that, when the cap is attached to the housing and the end opposite the marker end rests on a horizontally flat surface, the projection device stands upright on the surface for the projection device to project the multiple instances of the image.

4. The projection device of claim 1, comprising a power circuit connected to the light source and including:
a battery, and
a power switch, wherein operation of the power switch controls activation of the light source and hence projection of the multiple instances of the image.

5. The projection device of claim 1, wherein the non-parallel surfaces are internal to the multifaceted lens and the exterior of the multifaceted lens is a single surface.

6. The projection device of claim 1, wherein the non-parallel surfaces are internal to the multifaceted lens and the exterior of the multifaceted lens is substantially smooth.

7. The projection device of claim 1, wherein the non-parallel surfaces are on the exterior of the multifaceted lens.

8. The projection device of claim 1, wherein the multifaceted lens includes five or more non-parallel surfaces.

9. The projection device of claim 1, wherein the multifaceted lens is rotatably attached to the projection end such that the non-parallel surfaces are rotatable about a longitudinal axis of the projection device and thus such that the multiple instances of the image are rotatable as projected from the projection device.

10. A writing device comprising a writing tip on one end, a projection lens on the opposite end and a light source and a transparency bearing an image therebetween, the light source and the transparency aligned relative to each other and the projection lens such that light from the light source travels through the transparency and the projection lens and projects multiple instances of the image onto nearby surfaces.

11. The writing device of claim 10 including a cap releasably attachable to the writing device to cover the writing tip, the cap having a flat surface on which the projection device may stably stand upright on a horizontally flat surface.

12. The writing device of claim 10, whereby the projection lens is multi-faceted such that light that travels therethrough divides into portions corresponding to the multiple instances of the image.

13. The writing device of claim 10, wherein the projection lens includes non-parallel surfaces on a side of the multifaceted lens internal to the writing device and the exterior of the multifaceted lens is a single surface.

14. The writing device of claim 10, wherein the projection lens includes non-parallel surfaces on a side of the multifaceted lens external to the writing device and the interior of the multifaceted lens is a single surface.

15. The writing device of claim 10, wherein the projection lens includes non-parallel lenses, each non-parallel lens receiving some of the light from the light source that traveled through the transparency and each non-parallel lens projecting one instance from the multiple instances of the image onto a nearby surface.

16. The writing device of claim 10, wherein the projection lens is rotatably attached to the opposite end such that the projection lens is rotatable about a longitudinal axis of the writing device and such that the multiple instances of the image are rotatable as projected to the nearby surfaces.

17. A projection device comprising:
a housing having a first end and an interior;
a battery-powered light source held in the interior of the housing such that light from the battery-powered light source travels axially along the interior of the housing towards the first end;
a transparency bearing an image and axially aligned with the battery-powered light source in the housing such that light from the battery-powered light source travels axially along the interior of the housing towards the first end through the transparency; and
a lens disposed at the first end such that light from the battery-powered light source travels axially along the interior of the housing towards the first end through the transparency and out of the lens, wherein multiple simultaneous instances of the image are projected from the projection device.

18. The projection device of claim 17, wherein the lens is a multifaceted lens having non-parallel lenses and disposed at the first end such that light from the battery-powered light source travels axially along the interior of the housing towards the first end through the transparency and out of the multifaceted lens, wherein the non-parallel lenses divide the light into multiple portions such that the multiple instances of the image are projected from the projection device.

19. The projection device of claim 17, comprising:
a writing nib disposed on a second end of the projection device opposite the first end, the writing nib configured to receive ink from within the interior of the projection device and transfer the ink to a surface external to the projection device.

20. The projection device of claim 17, wherein the multifaceted lens is rotatably disposed at the first end such that the non-parallel lenses are rotatable about a longitudinal axis of the projection device such that the multiple instances of the image are rotatable as projected from the projection device.
